(19) United States
(12) Patent Application Publication
(10) Pub. No.: US 2012/0266242 A1
(43) Pub. Date: Oct. 18, 2012

(54) APPARATUS AND METHOD FOR DEFENDING DISTRIBUTED DENIAL OF SERVICE ATTACK FROM MOBILE TERMINAL

(75) Inventors: Jin-Seok YANG, Ansan-si (KR); Hyoung-Chun KIM, Seoul (KR)

(73) Assignee: ELECTRONICS AND TELECOMMUNICATIONS RESEARCH INSTITUTE, Daejeon (KR)

(21) Appl. No.: 13/396,874

(22) Filed: Feb. 15, 2012

(30) Foreign Application Priority Data
Apr. 13, 2011 (KR) 10-2011-0034360

(51) Int. Cl. G06F 21/00; G06F 11/30

(52) U.S. Cl. 726/23

(57) ABSTRACT

An apparatus for defending a Distributed Denial of Service (DDoS) attack from a mobile terminal is provided. The apparatus includes a monitoring unit, a transmission/non-transmission inquiry unit, and a critical file management unit. The monitoring unit monitors all network data transmitted from a mobile terminal to the outside based on the current mode of the mobile terminal. The transmission/non-transmission inquiry unit asks a user whether to transmit corresponding network data to the outside based on the results of monitoring. The critical file management unit manages a critical file which includes information about at least one protocol used by the mobile terminal and at least one service provided using the protocol.

### CROSS REFERENCE TO RELATED APPLICATION

This application claims the benefit of Korean Patent Application No.10-2011-0034360, filed on Apr. 13, 2011 which is hereby incorporated by reference in its entirety into this application.

### BACKGROUND OF THE INVENTION

1. Technical Field

The present invention relates generally to an apparatus and method for defending a Distributed Denial-of-Service (DDoS) attack from a mobile terminal, and, more particularly, to an apparatus and method for defending a mobile terminal against a DDoS attack by monitoring network data transmitted to the outside.

2. Description of the Related Art

Recently, the supply of personal portable mobile t erminals, such as smart phones, Personal Digital Assistants (PDAs) and template Personal Computers (PCs), has increased. The information of mobile terminals is easily exposed to the outside of a domain unlike fixed terminals, and a mobile terminal is easily attacked by vicious viruses because the mobile phones are always powered on.

The damage to such mobile terminals has increased because of vicious viruses, in particularly, DDoS. In order to solve this problem, anti-virus programs for analyzing received data and determining whether the data is vicious have been stored in mobile terminals. When data is received, whether the data is vicious or not is determined, and then the relevant data is removed or a relevant service is blocked.

However, in order for a mobile terminal to use anti-virus programs, the existence of a separate algorithm used to detect vicious viruses is required to determine vicious code, so that there is the problem in that it is difficult to manage zero-day attacks or unknown attacks.

### SUMMARY OF THE INVENTION

Accordingly, the present invention, has been made keeping in mind the above problems occurring in the prior art, and an object of the present invention is to provide an apparatus and method for defending a gainst a DDoS attack by monitoring network data transmitted from a mobile terminal to the outside.

In order to accomplish the above object, the present invention provides an apparatus for defending a Distributed Denial of Service (DDoS) attack from a mobile terminal, the apparatus including: a monitoring unit for monitoring all network data transmitted from the mobile terminal to an outside based on the current mode of the mobile terminal; and a transmission/non-transmission inquiry unit for asking a user whether to transmit corresponding network data to the outside based on the results of monitoring of the monitoring unit.

The monitoring unit may perform monitoring by selecting one between a first monitoring mode in which monitoring is performed for each protocol and for each service and a second monitoring mode in which monitoring is performed only for each protocol, based on the current mode of the mobile terminal.

The apparatus may further include a critical file management unit for managing a critical file which includes information about at least one protocol used by the mobile terminal and at least one service provided using the protocol.

The critical file includes a type field which displays a type for each protocol and for each service; a name field which displays a name for each protocol and for each service; and a threshold display field which displays an attack determination threshold set for each protocol and for each service.

The monitoring unit may operate in the first monitoring mode when the current mode of the mobile terminal corresponds to a stand-by mode and the value of the type field corresponds to a first value.

The monitoring unit may generate the results of monitoring by determining whether the transmission rate of the corresponding network data monitored for each protocol is greater than a relevant attack determination threshold, and by determining whether the transmission rate of the corresponding network data monitored for each service is greater than a relevant attack determination threshold, in the first monitoring mode.

The transmission/non-transmission inquiry unit may provide a determination request screen for asking the user whether to transmit the corresponding network data, which was monitored for each protocol and for each service and whose transmission rate is greater than the relevant attack determination threshold, to the outside.

The monitoring unit may operate in the second monitoring mode when the current mode of the mobile terminal corresponds to an activation mode and a value of the type field corresponds to a second value.

The monitoring unit may generate the results of monitoring by determining whether the transmission rate of corresponding network data monitored for each protocol in the second monitoring mode is greater than a relevant attack determination threshold.

The transmission/non-transmission inquiry unit may provide a determination request screen for asking the user whether to transmit the corresponding network data, which was monitored only for each protocol and whose transmission rate is greater than the relevant attack determination threshold, to the outside.

In order to accomplish the above object, the present invention provides a method for defending a DDoS attack from a mobile terminal, the method including determining a current mode of the mobile terminal; monitoring all network data transmitted from the mobile terminal to an outside based on the current mode of the mobile terminal; and asking a user whether to transmit corresponding network data to the outside based on the results of monitoring.

The DDoS attack prevention method may further include managing a critical file which includes information about at least one protocol used by the mobile terminal and at least one service provided using the protocol.

The critical file may include a type field which displays a type for each protocol and for each service; a name field which displays a name for each protocol and for each service; and a threshold display field which displays an attack determination threshold set for each protocol and for each service.

The monitoring may include, when the current mode of the mobile terminal corresponds to a stand-by mode and the value of the type field corresponds to a first value, generating the results of monitoring by determining whether the transmission rate of the corresponding network data monitored for each protocol is greater than a relevant attack determination threshold, and by determining whether the transmission rate of the corresponding network data monitored for each service is greater than a relevant attack determination threshold.

The asking of the user may include providing a determination request screen for asking the user whether to transmit the corresponding network data, which was monitored for each protocol and for each service and whose transmission rate is greater than the relevant attack determination threshold, to the outside.

The monitoring may include, when the current mode of the mobile terminal corresponds to an activation mode and the value of the type field corresponds to a second value, generating the results of monitoring by determining whether the transmission rate of corresponding network data monitored for each protocol in the second monitoring mode is greater than a relevant attack determination threshold.

The asking of the user may include providing a determination request screen for asking the user whether to transmit the corresponding network data, which was monitored only for each protocol and whose transmission rate is greater than the relevant attack determination threshold, to the outside.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically illustrating an apparatus for defending a mobile terminal against a DDoS attack according to the present invention;

FIG. 2 is a view illustrating an example of a critical file according to an embodiment of the present invention;

FIG. 3 is a view illustrating an example of a determination request screen according to an embodiment of the present invention; and

FIG. 4 is a flowchart illustrating a method for defending a mobile terminal against a DDoS attack according to an embodiment of the present invention.

### DESCRIPTION OF THE PREFERRED EMBODIMENTS

The present invention will be described in detail with reference to the accompanying drawings below. Here, in cases where the description would be repetitive and detailed descriptions of well-known functions or configurations would unnecessarily obscure the gist of the present invention, the detailed descriptions will be omitted. The embodiments of the present invention are provided to complete the explanation of the present invention to those skilled in the art. Therefore, the shapes and sizes of components in the drawings may be exaggerated to provide a more exact description.

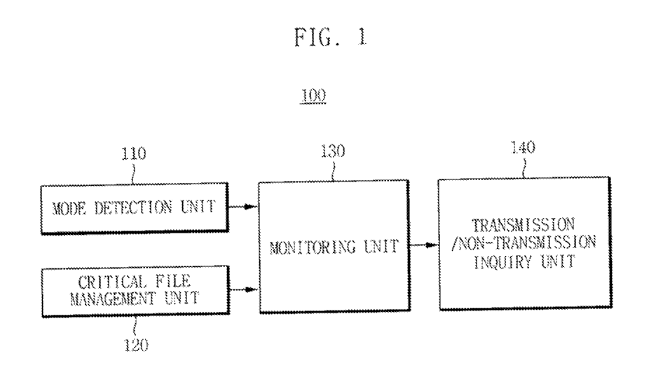

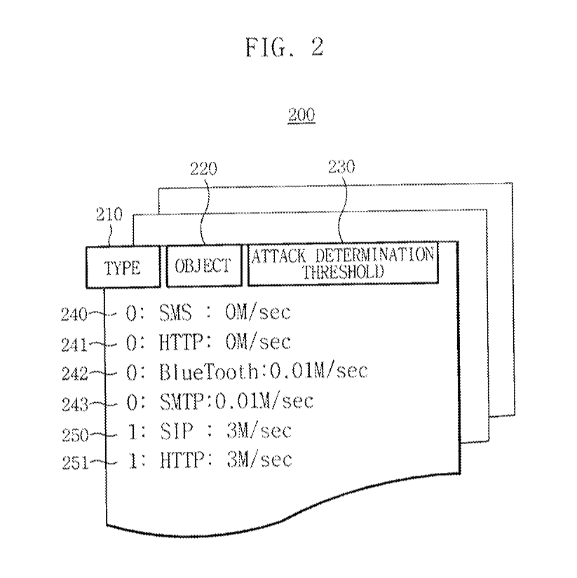

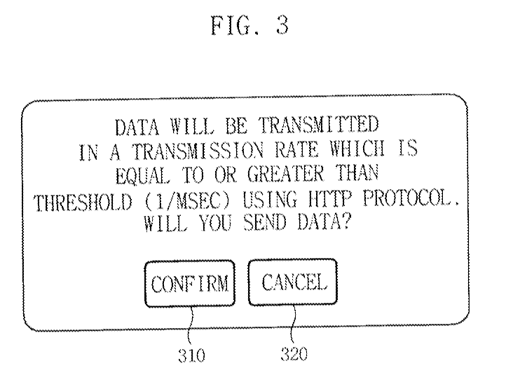

FIG. 1 is a view schematically illustrating an apparatus for defending a mobile terminal against a DDoS attack according to the present invention. FIG. 2 is a view illustrating an example of a critical file according to an embodiment of the present inventions FIG. 3 is a view illustrating an example of a determination request screen according to an embodiment of the present invention.

As shown in FIG. 1, a DDos attack defense apparatus 100 for defending a mobile terminal against a DDoS attack according to the embodiment of the present invention includes a mode detection unit 110, a critical file management unit 120, a monitoring unit 130, and a transmission/non-transmission inquiry unit 140.

The mode detection unit 110 detects the current mode of a mobile terminal using the current screen of the mobile terminal. Thereafter, the mode detection unit 110 transmits the current mode of the mobile terminal to the monitoring unit 130. The current mode of the mobile terminal according to the embodiment of the present invention may be set to stand-by mode or activation mode. Here, activation mode is defined as the status of a screen in which a user can input data using the mobile terminal, and stand-by mode is defined as all statuses of the screen excepting for the screen in activation mode.

The critical file management unit 120 manages a critical file including information about one or more protocols used in the mobile terminal and information about services provided using the protocols. The critical file according to the embodiment of the present invention includes a type field indicative of one or more protocols used in the mobile terminal, such as 3-Generation (3G), Wideband Code Division Multiple Access (WCDMA), High Speed Downlink Packet Access (HSDPA), Wi-Fi, Bluetooth and PC sync, and the types of services provided using the protocols, a name field indicative of a name, and a threshold display field indicative of one or more attack determination thresholds. Such information is previously set and stored. Here, in order to determine whether the purpose of the data that is being transmitted is to perform a DDoS attack, the attack determination thresholds have been previously set by experiments. The critical file management unit 120 reads previously set information about protocols and services from a relevant critical file based on the current mode of the mobile terminal.

The monitoring unit 130 receives the result of the detection related to the mode of the mobile terminal from the mode detection unit 110. In the case of a first monitoring mode in which the mode of the mobile terminal corresponds to stand-by mode and the value of the type field of the critical file corresponds to a first value, the monitoring unit 130 monitors network data which is transmitted from the mobile terminal to the outside for each protocol and for each service. That is, the monitoring unit 130 generates the result of monitoring by determining whether the transmission rate of network data is greater than a relevant attack determination threshold for each protocol and for each service in the first monitoring mode. Thereafter, the monitoring unit 130 transmits the result of the monitoring to the transmission/non-transmission inquiry unit 140.

Meanwhile, in the case of a second monitoring mode in which the current mode of the mobile terminal corresponds to the activation mode and the value of the type field of the critical file corresponds to a second value, the monitoring unit 130 monitors network data which is transmitted from the mobile terminal to the outside only for each protocol. That is, the monitoring unit 130 generates the results of monitoring by determining whether the transmission rate of the network data is greater than a relevant attack determination threshold for each protocol in the second monitoring mode. Thereafter, the monitoring unit 130 transmits the results of the monitoring to the transmission/non-transmission inquiry unit 140.

For example, as shown in FIG. 2, it is assumed that the critical file 200 of the mobile terminal includes services and protocols such as Short Message Service (SMS), Hypertext Transfer Protocol (HTTP), Simple Mail Transfer Protocol (SMTP), Session Initiation Protocol (SIP) and Bluetooth. When the mobile terminal operates in the first monitoring mode, the monitoring unit 130 monitors the protocols and services, that is, SMS 240, HTTP 241, Bluetooth 242 and SMTP 243, in which the first value of the type field 210 is set to “0”. That is, the monitoring unit 130 performs monitoring on all the relevant protocols and services in which the mode of the mobile terminal corresponds to stand-by mode and the value of a type field of the critical file is “0”.

Meanwhile, when the mobile terminal operates in the second mode, the monitoring unit 130 monitors protocols, that is, SIP 250 and HTTP 251, in which the second value of the type field 210 is set to “1”. That is, the monitoring unit 130 monitors only the relevant protocols in which the mode of the mobile terminal corresponds to the activation mode and the value of the type field of the critical file is “1”.

Referring to FIG. 1 again, in the case of first monitoring mode, the transmission/non-transmission inquiry unit 140 receives the results of monitoring, which were obtained by monitoring network data whose transmission rate was greater than a relevant attack determination threshold for each protocol and for each service, from the monitoring unit 130. Thereafter, the transmission/non-transmission inquiry unit 140 analyzes the results of the monitoring and transmits a determination request screen, used to ask a user to determine whether to transmit the network data whose transmission rate is greater than the relevant attack determination threshold, to the user for each protocol and for each service using the display unit (not shown) of the mobile terminal. An example of the determination request screen according to an embodiment of the present invention is illustrated in FIG. 3.

Further, in the case of the second monitoring mode, the transmission/non-transmission inquiry unit 140 receives the results of monitoring, which were obtained by monitoring the network data whose transmission rate is greater than a relevant attack determination threshold for each protocol, from the monitoring unit 130. Thereafter, the transmission/non-transmission inquiry unit 140 analyzes the results of monitoring and transmits the determination request screen, used to ask of a user to determined whether to transmit the network data whose transmission rate is greater than the relevant attack determination threshold, to the user for each protocol using the display unit (not shown) of the mobile terminal.

Further, when a user selects a confirmation region 310 on the determination request screen in order to transmit corresponding network data to the outside, the transmission/non-transmission inquiry unit 140 transmits the corresponding network data. Meanwhile, when a user has determined to block the transmission of the corresponding network data to the outside and then selects a cancellation region 320 on the determination request screen, the transmission/non-transmission inquiry unit 140 does not transmit the corresponding network data.

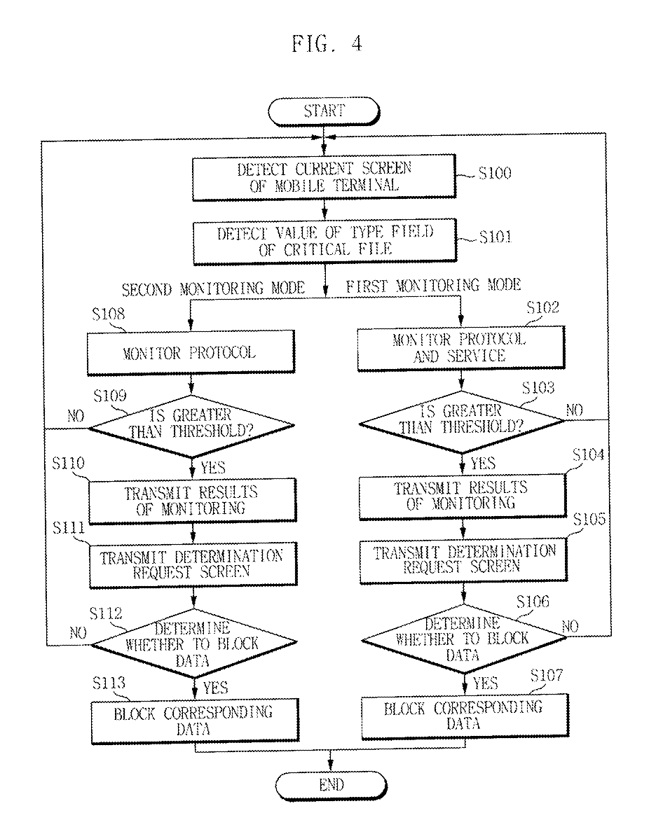

FIG. 4 is a flowchart illustrating the method of defending a mobile terminal against a DDoS attack according to an embodiment of the present invention.

As shown in FIG. 4, the mode detection unit 110 of the DDos attack defense apparatus 100 according to the embodiment of the present invention detects the current mode of a mobile terminal using the current screen of the mobile terminal at step S100. Thereafter, the mode detection unit 110 transmits the current mode of the mobile terminal to the monitoring unit 130.

The monitoring unit 130 receives the current mode of the mobile terminal. Thereafter, the monitoring unit 130 detects the value of the type field of a critical file stored in the critical file management unit 120 at step S101.

In the case of the first monitoring mode in which the current mode of the mobile terminal is stand-by mode and the value of the type field of the critical file corresponds to a first value, the monitoring unit 130 monitors network data which is transmitted from the mobile terminal to the outside for each protocol and for each service at step S102. The monitoring unit 130 determines whether the transmission rate of the network data is greater than a relevant attack determination threshold for each protocol and for each service during the process of monitoring at step S103.

If, as a result of the determination at step S103, it is determined that the transmission rate of the network data monitored for each protocol and for each service is greater than the relevant attack determination threshold, the monitoring unit 130 transmits the results of the monitoring, which were obtained by monitoring the network data for each protocol and for each service, to the transmission/non-transmission inquiry unit 140 at step S104.

The transmission/non-transmission inquiry unit 140 transmits a determination request screen, used to ask of a user to determine whether to transmit corresponding network data whose transmission rate is greater than the relevant attack determination threshold for each protocol and for each service, to the user at step S105. Thereafter, the transmission/non-transmission inquiry unit 140 determines whether the user requested that the corresponding network data be blocked using the determination request screen at step S106. Meanwhile, if, as the result of the determination at step S103, the transmission rate of the corresponding network data is not greater than the relevant attack determination threshold for each protocol and for each service, the process returns to step S100 and the same process is repeated.

If, as the result of the determination at step S106, the user requested that the corresponding network data be blocked, the transmission/non-transmission inquiry unit 140 blocks the corresponding network data at step S107. lf, as the result of the determination at step S106, the user did not request that the corresponding network data be blocked, the transmission/non-transmission inquiry unit 140 transmits the corresponding network data, and the process returns to step S100 and the same process is repeated.

Meanwhile, in the case of the second monitoring mode in which the current mode of the mobile terminal is an activation mode and the value of the type field of the critical file corresponds to the second value, the monitoring unit 130 monitors network data which is transmitted from the mobile terminal to the outside only for each protocol at step S108.

The monitoring unit 130 determines whether the transmission rate of relevant network data is greater than a relevant attack determination threshold for each protocol during the process of monitoring at step S109.

If, as a result of the determination at step S109, it is determined that the transmission rate of the corresponding network data monitored for each protocol is greater than the relevant attack determination threshold, the monitoring unit 130 transmits the results of monitoring, which were obtained by monitoring the network data for each protocol, to the transmission/non-transmission inquiry unit 140 at step S110.

The transmission/non-transmission inquiry unit 140 transmits the determination request screen, used to ask of a user to determine whether to transmit the corresponding network data whose transmission rate is geater than the relevant attack determination threshold for each protocol to the outside, to the user at step S111. Thereafter, the transmission/non-transmission inquiry unit 140 determines whether the user requested that the corresponding network data be blocked using the determination request screen at step S112. If, as the result of the determination at step S109, the transmission rate of the corresponding network data monitored for each protocol is not greater than the relevant attack determination threshold, the process returns to step S100 and the same process is repeated.

If, as a result of the determination at step S112, the user requested that the corresponding network data be blocked, the transmission/non-transmission inquiry unit 140 blocks the corresponding network data at step S113. If, as the result of the determination at step S112, the user did not request that the corresponding network data be blocked, the transmission/non-transmission inquiry unit 140 transmits the corresponding network data, and the process returns to step S100 and the same process is repeated.

As described above, unlike prior art methods of blocking vicious traffics using data transmitted to a mobile terminal, the DDos attack defense apparatus according to the embodiment of the present invention may block zero-day attacks or unknown attacks by transmitting data to an external network based on the results of determination performed by a user whether to transmit data when the transmission'rate of data to be transmitted from a mobile terminal to an external network is equal to or greater than an attack determination threshold.

Further, according to the embodiment of the present invention, monitoring is performed even in stand-by mode, and a user determines whether to transmit data when the transmission rate of the data is equal to, or greater than an attack determination threshold, thereby blocking vicious code attacks for the purpose of leaking personal information transmitted to an external network using SMS or wireless LAN.

Although the preferred embodiments of the present invention have been disclosed for illustrative purposes, those skilled in the art will appreciate that various modifications, additions and substitutions arc possible, without departing from the scope and spirit of the invention as disclosed in the accompanying claims.

What is claimed is:

1. An apparatus for defending a Distributed Denial of Service (DDoS) attack from a mobile terminal, the apparatus comprising:
a monitoring unit for monitoring all network data transmitted from the mobile terminal to an outside based on a current mode of the mobile terminal; and
a transmission/non-transmission inquiry unit for asking a user whether to transmit corresponding network data to the outside based on results of monitoring of the monitoring unit.

2. The apparatus as set forth in claim 1, wherein the monitoring unit performs monitoring by selecting one between a first monitoring mode in which monitoring is performed for each protocol and for each service and a second monitoring mode in which monitoring is performed only for each protocol, based on the current mode of the mobile terminal.

3. The apparatus as set forth in claim 2, further comprising a critical file management unit for managing a critical tile which includes information about at least one protocol used by the mobile terminal and at least one service provided using the protocol.

4. The apparatus as set forth in claim 3, wherein the critical file comprises:
a type field which displays a type for each protocol and for each service;
a name field which displays a name for each protocol and for each service; and
a threshold display field which displays an attack determination threshold set for each protocol and for each service.

5. The apparatus as set forth in claim 4, wherein the monitoring unit operates in the first monitoring mode when the current mode of the mobile terminal corresponds to a stand-by mode and a value of the type field corresponds to a first value.

6. The apparatus as set forth in claim 5, wherein the monitoring unit generates the results of monitoring by determining whether a transmission rate of the corresponding network data monitored for each protocol is greater than a relevant attack determination threshold, and by determining whether the transmission rate of the corresponding network data monitored for each service is greater than a relevant attack determination threshold, in the first monitoring mode.

7. The apparatus as set forth in claim 6, wherein the transmission/non-transmission inquiry unit provides a determination request screen for asking the user whether to transmit the corresponding network data, which was monitored for each protocol and for each service and whose transmission rate is greater than the relevant attack determination threshold, to the outside.

8. The apparatus as set forth in claim 4, wherein the monitoring unit operates in the second monitoring mode when the current mode of the mobile terminal corresponds to an activation mode and a value of the type field corresponds to a second value.

9. The apparatus as set forth in claim 8, wherein the monitoring unit generates the results of monitoring by determining whether a transmission rate of corresponding network data monitored for each protocol in the second monitoring mode is greater than a relevant attack determination threshold.

10. The apparatus as set forth in claim 9, wherein the transmission/non-transmission inquiry unit provides a determination request screen for asking the user whether to transmit the corresponding network data, which was monitored only for each protocol and whose transmission rate is greater than the relevant attack determination threshold, to the outside.

11. A method for defending a DDoS attack from a mobile terminal, the method comprising:
determining a current mode of the mobile terminal;
monitoring all network data transmitted from the mobile terminal to an outside based on the current mode of the mobile terminal; and
asking a user whether to transmit corresponding network data to the outside based on results of monitoring.

12. The method as set forth in claim 11, further comprising managing a critical file which includes information about at least one protocol used by the mobile terminal and at least one service provided using the protocol.

13. The method as set forth in claim 12, wherein the critical file comprises:
a type field which displays a type for each protocol and for each service;
a name field which displays a name for each protocol and for each service; and
a threshold display field which displays an attack determination threshold set for each protocol and for each service.

14. The method as set forth in claim 13, wherein the monitoring comprises, when the current mode of the mobile terminal corresponds to a stand-by mode and a value of the type field corresponds to a first value, generating the results of monitoring by determining whether a transmission rate of the corresponding network data monitored for each protocol is greater than a relevant attack determination threshold, and by determining whether a transmission rate of the corresponding network data monitored for each service is greater than a relevant attack determination threshold.

15. The method as set forth in claim 14, wherein the asking of the user comprises providing a determination request screen for asking the user whether to transmit the corresponding network data, which was monitored for each protocol and for each service and whose transmission rate is greater than the relevant attack determination threshold, to the outside.

16. The method as set forth in claim 13, wherein the monitoring comprises, when the current mode of the mobile terminal corresponds to an activation mode and a value of the type field corresponds to a second value, generating the results of monitoring by determining whether a transmission rate of corresponding network data monitored for each protocol in the second monitoring mode is greater than a relevant attack determination threshold.

17. The method as set forth in claim 16, wherein the asking of the user comprises providing a determination request screen for asking the user whether to transmit the corresponding network data, which was monitored only for each protocol and whose transmission rate is greater than the relevant attack determination threshold, to the outside.
